(19) United States
(12) Patent Application Publication
(10) Pub. No.: US 2017/0006890 A1
(43) Pub. Date: Jan. 12, 2017

(54) PRODUCTION OF CHEESE

(71) Applicant: DSM IP ASSETS B.V., TE Heerlen (NL)

(72) Inventors: Ben Rudolf DE HAAN, Echt (NL); John Mark FARAGHER, Echt (NL)

(73) Assignee: DSM IP Assets B.V., Heerlen (NL)

(21) Appl. No.: 15/117,706

(22) PCT Filed: Feb. 13, 2015
(86) PCT No.: PCT/EP2015/053109

§ 371 Date: Aug. 9, 2016

Related U.S. Application Data
(60) Provisional application No. 62/076,613, filed on Nov. 7, 2014.
(60) Provisional application No. 61/939,312, filed on Feb. 13, 2014.

(51) Int. Cl. A23C 19/10

(52) U.S. Cl. CPC A23C 19/10

(57) ABSTRACT

The present invention relates to a process for producing cheese. The method is particularly suitable for shredded cheese or block cheeses. More in particular, the process comprises the step of adding an antifungal to the cheese. Furthermore, the present invention relates to a device for producing cheese.

### FIELD OF THE INVENTION

The present invention relates to a process for producing cheese. More in particular, the process comprises the step of adding an antifungal agent during the production of cheese.

### BACKGROUND OF THE INVENTION

Production of cheese has been steadily increasing in the US for the past fifteen years. Consumer acceptance and demand for cheese, particularly shredded cheese, have been a contributing factor in the growth of the overall cheese market. Shredded cheese is currently the second largest category of cheese sold in the US. The sale of shredded cheese is estimated to be about 15% of the about $10 billion cheese market.

Consumers expect high quality with regard to flowability, functionality and appearance of shredded cheese. In order for producers to deliver high quality shredded cheese, the introduction of processing aids such as anti-caking agents has become essential. Shredded cheese is coated with an anti-caking agent to inhibit the tendency of the cheese shreds to stick to each other and cake. Currently, powdered cellulose based and/or starch based anti-caking agents are most common in the shredded cheese industry.

It has become common practice for cheese to be coated with an antifungal agent to inhibit the growth of moulds on the surface of the cheese and extend the shelf-life of the cheese. Natamycin, a natural polyene macrolide preservative which is produced by fermentation using Streptomyces natalensis, is often used as antifungal agent for cheese, since it is far more effective against moulds and yeast than sorbates and propionates. For shredded cheese, natamycin can be applied in dry form, usually as part of the anti-caking agent blend.

Shredded cheese is usually coated by mixing the anti-caking blend and cheese in a tumble drum. Because of the tumbling action, the process is very dusty. This dust is a source of environmental pollution, worker hazard and unhygienic conditions in the plant.

The blend may also be unevenly distributed over the shredded cheese leaving areas of the shredded cheese uncoated. This may lead to mould growth and consequently a shortened shelf-life of the shredded cheese product. This normally causes the shredded cheese producers to apply the anti-caking agent in excess to compensate for the loss leading to higher costs of production.

To remove some of the disadvantages, it has been suggested to apply dry anti-caking agent blends electrostatically (see Elayedath & Barringer, 2002). However, electrostatic coating of shredded cheese still has the disadvantage of high dustiness and concomitant worker exposure to dust inhalation. Furthermore, electrostatic coating leads to considerable amounts of waste and an increase in production costs.

Alternatively, it has been suggested to apply antifungal agents in liquid form either onto the anti-caking agent or directly onto the shredded cheese (see U.S. Pat. No. 6,291,436). However, a big disadvantage of this solution is that shredded cheese producers need to have many different liquid formulations comprising the antifungal agents in house, in case they want to be able to quickly adapt the formulation to the type of cheese to be treated. To have many different liquid formulations in house is disadvantageous for economic reasons. Besides that, liquid formulations only have a limited shelf-life and therefore could become spoiled after a certain period of time.

Ergo, there is a significant need for processes for producing shredded cheese that do not have any of the above-mentioned disadvantages.

### SUMMARY OF THE INVENTION

The present invention relates to the field of cheese, particularly shredded cheese and block cheese, and in-line processes to produce them. In one aspect the invention relates to an in-line process for producing cheese, wherein a fluid stream comprising an aqueous antifungal composition is mixed with another fluid stream to obtain a single fluid stream and the resulting single fluid stream is sprayed onto the cheese.

In another aspect the invention relates to a device for producing cheese comprising means for transporting at least two fluid streams to a mixer, a mixer, means for transporting a single fluid stream from the mixer, and means for spraying the single fluid stream onto the cheese. The device may comprise a control unit able to adapt the ratio between the at least two fluid streams to apply a specific amount of a component, such as for instance the antifungal composition, to the cheese.

### DETAILED DESCRIPTION OF THE INVENTION

To overcome the above disadvantages, the invention pertains to a process for producing cheese, the process comprising the steps of (a) providing at least two fluid streams, wherein at least one of said fluid streams comprises an aqueous antifungal composition, (b) mixing the at least two fluid streams to obtain a single fluid stream, said single fluid stream comprising an antifungal composition, and (c) spraying the single fluid stream onto the cheese. The at least two fluid streams can be pumped to the device where the mixing takes place, e.g. a mixer, and the resulting single fluid stream can be pumped to a device used for spraying the single fluid stream onto the cheese. Preferably, the resulting single fluid stream comprises an aqueous antifungal composition.

The method of the invention is particularly suitable for shredded cheese. However, the inventors have realized that the method is also very suitable for blocked cheese. In one embodiment the cheese is shredded cheese. In another embodiment the cheese is blocked cheese.

One or more pumps can be used for the pumping. The pumps may be controlled by a control unit able to adapt the ratio between the at least two fluid streams to apply a specific amount of a component, such as for instance the antifungal composition, to the cheese. As a consequence thereof it is possible to readily adjust the content of the single fluid stream and the amounts of each component in the single fluid stream. With the process and devices according to the invention the amount of antifungal composition added to the cheese can be optimised and rapidly adjusted to the actual need (that may depend on the type of cheese used).

The antifungal composition is preferably a polyene antifungal composition. The polyene antifungal composition is preferably a natamycin composition.

“Shredded cheese” as used herein refers to cheese that is typically first comminuted to form relatively small pieces of cheese. The pieces can have a variety of different forms including diced form, shredded form, grated form, sliced form, powdered form, to name just a few. All these forms are meant to be included under the term “shredded cheese” as used herein. One of skill in the art can readily adapt a grinding or shredding apparatus to yield these forms.

A block cheese as used herein refers to a solid piece of cheese, the dimensions can range from between a cubic meter of cheese to a slice of cheese, and everything in between. Block cheese also encompasses smaller blocks and cubes.

The cheese to be produced may be a soft cheese, a semi-soft cheese, a semi-hard cheese or a hard cheese. It may be a ripened or unripened cheese. It may be a processed or a non-processed cheese. The cheese may also be a cheese substitute product or an imitation cheese product. The cheese may also be a blend of different cheeses. Suitable cheeses include, by way of non-limiting example, Cheddar cheese, Colby cheese, Monterey Jack, Havarti cheese, Muenster cheese, Brick cheese, Gouda cheese, Mozzarella cheese, and the like.

In step (c) of the process the single fluid stream comprising an antifungal composition is sprayed onto the cheese. When the cheese is a shredded cheese, part of the polyene antifungal composition may migrate into the cheese, such that the antifungal composition is more or less distributed over the entire mass of the shredded cheese. Because of its small dimensions, part or even most or all of the shredded cheese will be in contact with the polyene antifungal composition. Likewise, if the cheese is a block cheese, part of the polyene antifungal composition may also move into the cheese, but typically at least part of the cheese (the interior) will be free of the polyene antifungal composition.

In an embodiment the process is an in-line process. An in-line process disclosed herein refers to one where the production process of the fluid stream that is to be sprayed and the actual spraying process of the fluid stream are integrated in a single process. It may be that the fluid stream is sprayed immediately after it is produced. It may also be that the fluid stream is first stored for a period of time, preferably a short period of time such as between 30 seconds and 30 minutes.

In an embodiment the mixing is done without agitation. In an embodiment the mixing is performed by a static mixer or a motionless in-line mixer. If necessary, two or more mixers can be used. These can be the same, but may also be different, e.g. a static mixer in combination with a motionless in-line mixer. The mixers may be placed in series or parallel.

A static mixer is generally build from short elements which are combined in a typical manner. The elements cause a fluid stream to be separated and combined again. The separation and combining step are repeated, leading to mixing of the components in the fluid stream. The use of a static mixer or a motionless in-line mixer has many advantages. Firstly, no mechanical moving parts are required, no wearing out of mechanical equipment occurs, and very little maintenance or labour costs are required. Secondly, there is little or no electrical power requirement, so the mixing can be done in remote areas. Thirdly, little or no sound is produced during use. Fourthly, these mixers are smaller than conventional mixing tanks and processing capacity is easily adjusted by either adding more mixers to a given tandem design (series or parallel) or by increasing the diameter of the mixers to increase the throughput. Fifthly, it is easily modified for use with hazardous or corrosive materials. Contrary to most conventional mixing tanks, the mixers are sealed and self-contained and there is no possibility of hazardous vapours escaping from the mixed fluid streams and no need for air exchange to prevent explosive conditions around the mixers. Sixthly, the mixers are easily cleaned by a contained flush, without the need to enter into a vessel for maintenance or cleaning. Finally, the mixers can be mounted in any direction or configuration and can be moved or replaced within minutes. The mixers can have the form of a pipe through which the fluid streams are passed.

In an embodiment the concentration of natamycin in the single fluid stream after mixing is in the range of 50 ppm to 50,000 ppm, preferably 100 ppm to 40,000 ppm, more preferably 150 ppm to 30,000 ppm and in particular 200 ppm to 20,000 ppm.

In an embodiment the single fluid stream further comprises a compound selected from the group consisting of a sticking agent, a carrier, a colouring agent, a protective colloid, an adhesive, a thickening agent, a sequestering agent, a thixotropic agent, a surfactant, a further antimicrobial compound, a detergent, a preservative, a spreading agent, a filler, a spray oil, a flow additive, a mineral substance, a solvent, a dispersant, an emulsifier, a wetting agent, a stabiliser, an antifoaming agent, a buffering agent, an UV-absorber, an antioxidant, an anti-caking agent and combinations thereof. The compound may originate from one or more of the at least two fluid streams, but may also be added to the single fluid stream through another stream.

In an embodiment the concentration of natamycin in the at least one of said fluid streams before mixing is in the range of 2000 ppm to 1,000,000 ppm, preferably 1500 ppm to 750,000 ppm and in particular 1000 ppm to 500,000 ppm.

In an embodiment the shredded cheese comprises an anti-caking agent. The anti-caking agent can be added before, during or after spraying of the single fluid stream onto the shredded cheese. Preferably, the anti-caking agent is selected from the group consisting of celluloses (e.g. microcrystalline or powdered), polysaccharides, silicates, starches, flours, sulphates (e.g. calcium sulphate), minerals, phosphates, clays, fibres and combinations thereof. The cheese may also comprise other compounds such as salts, vitamins, flavours, colorants, anti-oxidants, spices, meat products, to name just a few.

In an embodiment the cheese is shredded cheese and the amount of the antifungal composition that is sprayed is such that the shredded cheese comprises between 1-20 ppm after the spraying. More specifically, if the cheese is shredded cheese, the amount of the antifungal composition that is sprayed is such that the antifungal composition amount of final packaged product comprises between 1-20 ppm.

In an embodiment the cheese is a block cheese, and the amount of the antifungal composition sprayed onto the surface of the block cheese is between 1-20 mg/cm².

In an embodiment step (a) of the process of the invention comprises providing at least two fluid streams, wherein at least one of said fluid streams comprises an aqueous antifungal composition and wherein the other fluid stream comprises an aqueous composition without antifungal agent. The fluid stream comprises an aqueous composition without antifungal agent may be a fluid stream consisting of water, but may also be an aqueous composition comprising other compounds, such as a buffer composition.

In an embodiment the cheese may be packaged after the spraying step. Packaging is done according to techniques known to the skilled artisan.

In an embodiment the cheese, preferably shredded cheese, comprises 0.5 to 50 ppm, preferably 1 to 20 ppm, natamycin after spraying.

In an embodiment the invention also pertains to a device for producing cheese, preferably shredded cheese and/or block cheese, said process comprising (a) means for transporting at least two fluid streams to a mixer, (b) a mixer, (c) means for transporting a single fluid stream from the mixer, and (d) means for spraying a single fluid stream onto the cheese. In an embodiment the device further comprises means for adjusting the ratio of the at least two fluid streams. In an embodiment the means for adjusting the ratio of the at least two fluid streams are placed before the fluid streams reach the mixer. The mixer is preferably a static mixer or a motionless in-line mixer. In a preferred embodiment the means (a), mixer (b), means (c) and means (d) are placed in line.

The device may comprise a control unit able to adapt the ratio between the at least two fluid streams to apply a specific amount of a component, such as for instance the antifungal composition, to the cheese. In an embodiment the control unit is a computer and/or automated controller able to regulate the amount of a component, such as for instance the antifungal composition, in the single fluid stream.

### LEGEND TO THE FIGURE

FIG. 1. Shown are two possible configurations of a device for producing cheese comprising a means for transporting at least two fluid streams to a mixer (metering pumps); a mixer (inline mixer and/or mixing tank); a means for transporting a single fluid stream from the mixer; and a means for spraying the single fluid stream onto the shredded cheese (comprising nozzles). The concentrate container may comprise an antifungal composition.

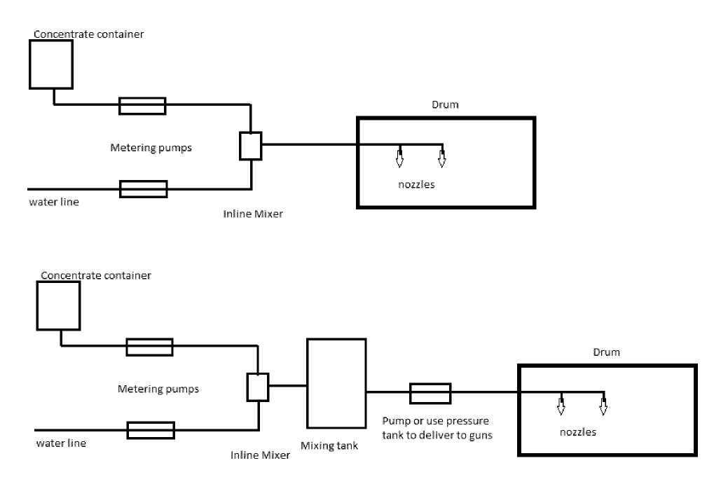

### REFERENCES

Elayedath S & Barringer SA (2002), Electrostatic powder coating of shredded cheese with antimycotic and anticaking agents. Innovative Food Science and Emerging Technologies 3:385-390.

1. A process for producing cheese, the process comprising the steps of:
a. providing at least two fluid streams, wherein at least one of said fluid streams comprises an aqueous antifungal composition,
b. mixing the at least two fluid streams to obtain a single fluid stream, said single fluid stream comprising an antifungal composition, and
c. spraying the single fluid stream onto the cheese.

2. Process according to claim 1, wherein the cheese is shredded cheese and/or a block cheese.

3. A process according to claim 1, which is an in-line process.

4. A process according to claim 1, wherein the mixing is done without agitation.

5. A process according to claim 1, wherein the mixing is performed by a static mixer or a motionless in-line mixer.

6. A process according to claim 1, wherein the antifungal composition is a natamycin composition.

7. A process according to claim 6, wherein the concentration of natamycin in the single fluid stream after mixing is in the range of 50 ppm to 50,000 ppm.

8. A process according to claim 1, wherein the single fluid stream further comprises a compound selected from the group consisting of a sticking agent, a carrier, a colouring agent, a protective colloid, an adhesive, a thickening agent, a sequestering agent, a thixotropic agent, a surfactant, a further antimicrobial compound, a detergent, a preservative, a spreading agent, a filler, a spray oil, a flow additive, a mineral substance, a solvent, a dispersant, an emulsifier, a wetting agent, a stabiliser, an antifoaming agent, a buffering agent, an UV-absorber, an antioxidant and combinations thereof.

9. A process according to claim 6, wherein the concentration of natamycin in the at least one of said fluid streams before mixing is in the range of 2000 ppm to 1,000,000 ppm.

10. A process according to claim 1, wherein the shredded cheese comprises an anti-caking agent.

11. A process according to claim 9, wherein the anti-caking agent is selected from the group consisting of celluloses (e.g. microcrystalline or powdered), polysaccharides, silicates, starches, flours, sulphates (e.g. calcium sulphate), minerals, phosphates, clays, fibres and combinations thereof.

12. A process according to claim 1, wherein step (a) of the process comprises providing at least two fluid streams, wherein at least one of said fluid streams comprises an aqueous antifungal composition and wherein the other fluid stream comprises an aqueous composition without antifungal agent.

13. A device for producing cheese comprising:
a. means for transporting at least two fluid streams to a mixer,
b. a mixer,
c. means for transporting a single fluid stream from the mixer, and
d. means for spraying the single fluid stream onto the cheese.

14. A device according to claim 12, further comprising means for adjusting the ratio of the at least two fluid streams.

15. A device according to claim 12, wherein the mixer is a static mixer or a motionless in-line mixer.

16. A device according to claim 12, wherein the means (a), mixer (b), means (c) and means (d) are placed in line.
